(19) United States
(12) Patent Application Publication
(10) Pub. No.: US 2012/0114009 A1
(43) Pub. Date: May 10, 2012

(54) FORWARD-FLYBACK POWER SUPPLY USING AN INDUCTOR IN THE TRANSFORMER PRIMARY AND METHOD OF USING SAME

(76) Inventors: Jeffrey Melvin, Hartland, WI (US); Jason Griesbach, Richfield, WI (US); Ted Casper, West Bend, WI (US)

(21) Appl. No.: 12/939,398

(22) Filed: Nov. 4, 2010

(51) Int. Cl. H05B 6/06; H02M 3/335

(52) U.S. Cl. 373/150; 363/21.12

(57) ABSTRACT

A power supply (300) includes a rectification means (303) for providing a voltage from an AC mains input (301). An inverter (307) is used for supplying a switched AC voltage at high frequency from the rectified voltage to a transformer (311) for modifying the amplitude and/or providing galvanic isolation of the switched AC voltage. Output rectification (313) is used to convert the switched AC voltage at the secondary of the transformer back to a rectified voltage. An inductor (309) is used in series with the primary of the transformer (311) for reducing the peak and ripple current in both the primary and secondary of the transformer while minimizing or eliminating the need for an inductive component in the output filter of the supply.

### FIELD OF THE INVENTION

The present invention generally relates to power supplies and more particularly to switching power supplies for providing substantially high output voltages.

### BACKGROUND OF THE INVENTION

Many different types of power supplies have been developed for use in applications requiring a high output voltage. These devices often supply either high direct current (DC) or alternating current (AC) voltages to one or more output loads. One application for this type of high voltage supply is for use with a vacuum tube oscillator. This type of oscillator is used for providing substantially high power radio frequency (RF) voltages at its output.

Many factors commonly affect the design of these types of power supplies. These factors include the amount of power needed from the supply, the duration and stability of the voltage and current under various load conditions, and the acceptable range of input voltages for supply operation. Moreover, the load placed on the input power source of the supply and the efficiency at which the supply can convert power are also factors in its design and operation.

Power supplies for electronic devices can be broadly divided into either linear or switching power supplies. A linear supply is usually a relatively simple design but becomes increasingly bulky and heavy for high voltage and high current equipment. This is due to the use of relatively large mains-frequency transformers operating at 50-60 Hz. The overall size of a linear supply can be very large and expensive to manufacture depending on its application. In contrast, a “switching” or switched-mode power supply that has the same voltage and current ratings as a linear supply will be smaller in size but will be more complex in construction. This type of switched-mode supply works on a different principle of operation so that either a DC input voltage or a rectified AC input voltage can be used as a power source.

In operation, an input or supply voltage is switched on and off at a very high speed (typically 10 kHz to 1 MHz) by electronic switching circuitry, called an inverter. The high-frequency inverter then drives a smaller, lighter, and less expensive transformer to step-up or step-down the switched voltage to a specific amplitude. This amplitude is typically controlled by varying the “on” time, or duty cycle of the inverter. The high frequency output of the transformer is rectified and filtered to remove the switching frequency components and average the output waveform. In addition to transformer size, another advantage to this design is that much smaller filter elements, such as inductors and capacitors, are used when filtering the high frequency signal components. This is in contrast to the larger filter elements used in the design of a linear power supply operating at a 50-60 Hz mains frequency.

FIG. 1 illustrates a prior art block diagram of a linear type supply known as a phase fired controller mains supply 100. The supply 100 includes a mains input 101 that feeds a phase fired control 103. The phase fired control 103 controls the conduction angle of the mains frequency that supplies a mains frequency transformer 105 used to step up the voltage supplied at its primary winding. Optionally, the mains frequency transformer 105 can include multiple taps for allowing operation from various nominal mains input voltages. The secondary winding or output of the mains frequency transformer 105 feeds an output rectifier 107. The output rectifier 107 is used for providing a phase chopped full wave rectified AC waveform to a load 109. The voltage at the load 109 is monitored by a phase controller 111 so that the phase angle of the phase fired controller 103 can regulate output voltage at the load 109.

In contrast to that shown in FIG. 1, a switched supply topology uses differing methods to control voltage at the load. One commonly used topology is referred to as a forward converter, which uses the turns ratio of the transformer to increase or decrease the output voltage. This technique has the advantage of providing galvanic isolation for the load. In the forward converter, an input voltage to the transformer is switched using a variable duty cycle. This technique is also called pulse width modulation (PWM). The transformer provides a PWM voltage at its secondary that is a scaled version of the PWM primary voltage. The PWM secondary voltage is filtered to provide an output voltage that has the average value of the PWM secondary voltage. The output voltage is subsequently controlled by varying the PWM duty cycle.

Another switching supply topology is known as a flyback converter. In the flyback converter, the input voltage to the transformer is switched with a variable duty cycle. While applying a voltage to the transformer primary, the transformer stores the applied energy as magnetic flux rather than delivering it to the load. When the primary voltage is switched off, the energy stored in the transformer is delivered to the transformer secondary winding and a load at its output. This supply topology includes a capacitor at its output for energy storage, delivering power to the load during the “on” time of the transformer primary. Thus, the flyback converter technique uses the transformer as an energy storage device while also providing galvanic isolation between the transformer primary and secondary windings.

An issue associated with switching power supplies using PWM for varying the output voltage involves parasitic oscillation or “ringing.” PWM power supplies can be plagued with ringing waveforms that can degrade performance, impact electromagnetic interference (EMI) measurements, and cause transformer failure in high power applications. Ideally, the forward converter should generate sawtooth shaped current waveforms in the output filter inductor. This provides a scaled version of the waveform shape at the transformer primary. However, the basic forward converter often includes undesirable parasitic oscillations also known as “ringing” due to parasitic inductances and capacitances in both the transformer and output filter inductor. FIG. 2 shows a graphical representation of oscilloscope waveforms of the primary current 201 and voltage 203 appearing at the primary winding of a switching power supply transformer. The graph shows an undesirable amount of oscillation or “ringing” at the primary.

In use, there are numerous parasitic elements that cause ringing in a power supply circuit. These factors include, but are not limited to, printed circuit board trace inductance, transformer leakage inductance, transformer magnetizing inductance, transformer primary capacitance, transformer primary-to-secondary capacitance and transformer secondary capacitance. Additional factors include, output filter inductor capacitance, output filter capacitor inductance, switching transistor output capacitance and diode junction capacitance. In many cases, these elements can be voltage and frequency dependent such as in semiconductor junction capacitances and transformer leakage inductance. Ringing waveforms are typically suppressed using snubbers and clamp circuits for suppressing a dominant parasitic; however, these techniques are not always effective for high voltage and high power applications.

Thus, it is important to protect the power supply circuit in differing modes of operation under varying operating conditions. Since transient events can excite circuit resonances, circuit failure often can occur during such transients due to the additional stress placed on power supply components. In the case illustrated in FIG. 2, the power supply transfer function is not monotonic, which results in an unstable control loop and an undesirable power supply design.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a prior art block diagram of a standard phase fired control type power supply.

FIG. 2 is a graph illustrating the primary current and voltage of a transformer which shows the characteristics of oscillation or ringing at the transformer primary.

FIG. 3 is a schematic diagram illustrating a forward-flyback power supply topology used in accordance with an embodiment of the invention.

FIG. 4 is a schematic diagram of a full bridge inverter used in connection with the switching power supply in accordance with an embodiment of the invention.

FIG. 5 is a graph illustrating the primary current and voltage of the transformer using a forward-flyback topology as shown in FIG. 3.

FIG. 6 is a schematic diagram of an RF oscillator used in connection with the switching power supply shown in FIG. 3.

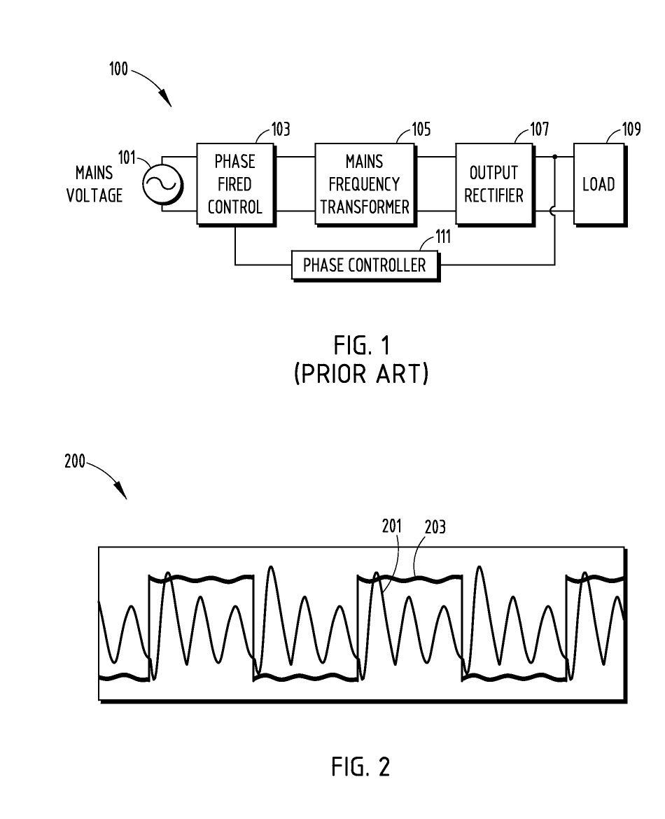

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PREFERRED EMBODIMENTS

Before describing in detail embodiments that are in accordance with the present invention, it should be observed that the embodiments reside primarily in combinations of method steps and apparatus components related to a forward-flyback power supply. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a forward-flyback power supply as described herein. The non-processor circuits may include, but are not limited to, a radio receiver, a radio transmitter, signal drivers, clock circuits, power source circuits, and user input devices. As such, these functions may be interpreted as steps of a method to supply power to an RF oscillator in an induction furnace. Alternatively, some or all functions could be implemented by a state machine that has no stored program instructions, or in one or more application specific integrated circuits (ASICs), in which each function or some combinations of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

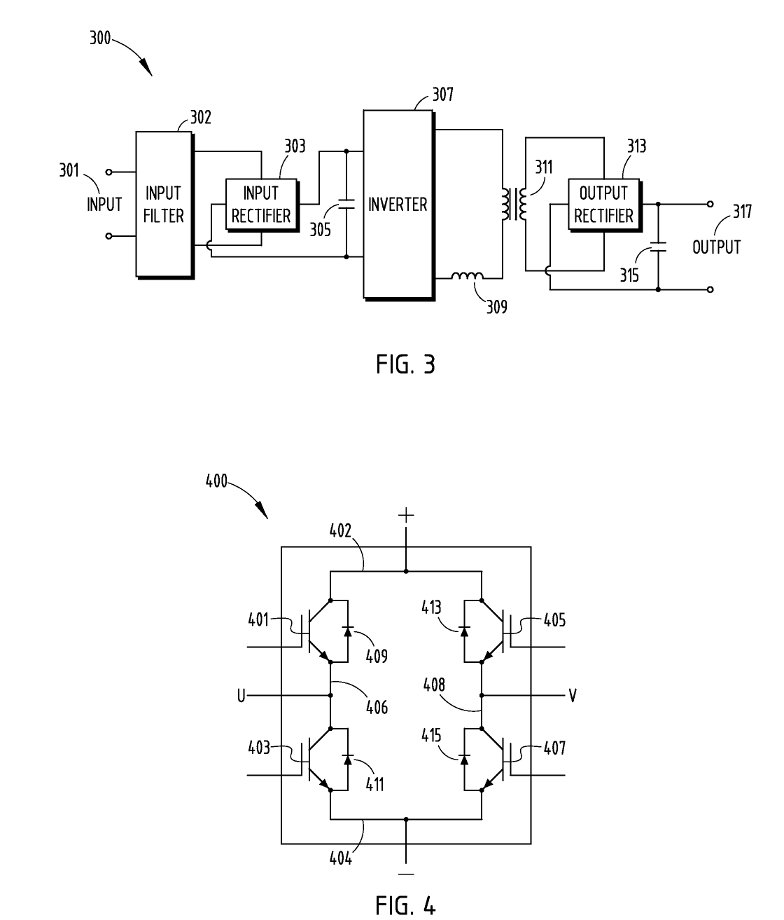

FIG. 3 is a schematic diagram illustrating a forward-flyback power supply 300 using an inductor 309 in series with a primary winding of a transformer 311. The power supply 300 is used to power an RF oscillator in accordance with an embodiment of the invention. The power supply 300 includes an AC mains voltage input 301 that typically has an input line voltage between 85-265 VAC at 47-63 Hz. An input filter 302 can be used between the AC mains 301 and an input rectifier 303 for reducing harmonic distortion of the AC mains voltage or other voltage source.

The input rectifier 303 includes one or more switching devices used to provide a rectified voltage to an inverter 307. A capacitor 305 is used across an input of the inverter 307 for sustaining peak currents. The capacitor 305 also acts as a “snubber” for inverter current transients and prevents the switching currents of the inverter 307 from affecting the AC mains voltage input 301. The inverter 307 uses a switching controller (not shown) for switching the input voltage at a substantially high frequency to drive an input circuit comprised of the series combination of the inductor 309 and the primary winding of the transformer 311. The voltage at the secondary winding of the transformer 311 feeds an output rectifier 313. An output capacitor 315 is used to smooth the voltage at the output 317 for supplying one or more load(s) (not shown). Thus, the inductor 309 is connected in series with the primary winding the transformer 311 for filtering an output voltage applied to a load coupled with the secondary winding of transformer 311. For example, using a 175-275 VAC input and a 4 kVAC/0.5 A output at a 25 kHz switching frequency, the inductor 309 might have an optimized value in a range between 18-4701 when used with a transformer with a turns ratio between 1:12 and 1:10. Although a single transformer 311 is shown, it should be evident to those skilled in the art that alternative embodiments using a plurality of transformers having one or more primary and secondary windings may also be used.

FIG. 4 is a schematic diagram of a switching inverter 400 comprised of a plurality of switching devices used in combination to form parallel connected half bridge networks. The inverter 400 uses two parallel connected half bridges. The first half bridge is comprised of switching devices 401, 403, 409, 411 and the second half bridge is comprised of switching devices 405, 407, 413, 415. In this diagram, the switching devices are represented as insulated gate bipolar transistors (IGBTs) 401, 403, 405, 407 and diodes 409, 411, 413, 415. Since IGBTs can only pass current from collector to emitter, anti-parallel diodes 409, 411, 413, 415 are included to allow current to flow in the opposite direction.

The first half bridge is a switching network formed using first transistor pair 401, 403 connected in series between the positive (+) and negative (−) rails of a respective input bus 402, 404 with diodes 409, 411 connected in anti-parallel across each transistor. The series connection is formed from the emitter of transistor 401 to the collector of transistor 403 and the anti-parallel connections are formed with the diode 409 anode and cathode tied to transistor 401 emitter and collector, respectively, and diode 411 anode and cathode tied to transistor 403 emitter and collector, respectively. The second half bridge is identically connected and placed in parallel with the first half bridge in a manner such that the collectors of transistors 401, 405 and cathodes of diodes 409, 413 are connected by the positive (+) bus and the emitters of transistors 403, 407 and anodes of diodes 411, 415 are connected by the negative (−) bus. These positive and negative bus connections (+,−) provide the input voltage connections to the inverter 400. The center points of each half bridge, that is the emitter-collector connection between first transistor pair 401, 403 and anode-cathode connection between first diode pair 409, 411 (U) and the emitter-collector connection between second transistor pair 405, 407 and anode-cathode connection between second diode pair 413, 415 (V), are used for providing the output voltage connections 406, 408 of the inverter.

In use, the inverter 400 is operated as a phase controlled full bridge that includes a first half bridge and a second half bridge, as previously described. Unlike a conventional pulse width modulated inverter, each half bridge is continuously operated at a substantially fifty percent (50%) duty cycle. In doing so, the full bridge provides four switching states dependent on a switching voltage applied to the switching devices 401, 403, 405, 407.

In a first state, switching devices 401, 407 are switched to an “on” state and the inverter 400 is “on” providing a positive output voltage at output 406, 408. In a second state, switching devices 401, 405 are in an “on” state and the inverter is “off” with a shorted output. In a third state, switching devices 403, 405 are in an “on” state and the inverter is “on” with a negative output voltage at output 406, 408. Finally, in a fourth state, switching devices 403, 407 are in an “on” state and the inverter is “off” with a shorted output.

When in operation, the inverter 400 delivers a switched output voltage to the output 406, 408. The output voltage is based upon the voltage input at the bus 402, 404 and is controlled by varying the phase between each half of the full bridge inverter 400. When each half of the bridge is switched in-phase, either transistors 401, 405 or transistors 403, 407 will be “on” at the same time, providing no output power. When each half of the bridge is switched out of phase, either transistors 401, 407 or transistors 403, 405 will be “on” at the same time. This provides full power at the output 406, 408. The output power can be varied continuously between zero and full power by changing the phase delay between each half of the bridge. Although a single inverter output 406, 408 is shown, it should be evident to those skilled in the art that alternative embodiments using a plurality of half bridges having one or more inverter outputs may also be used.

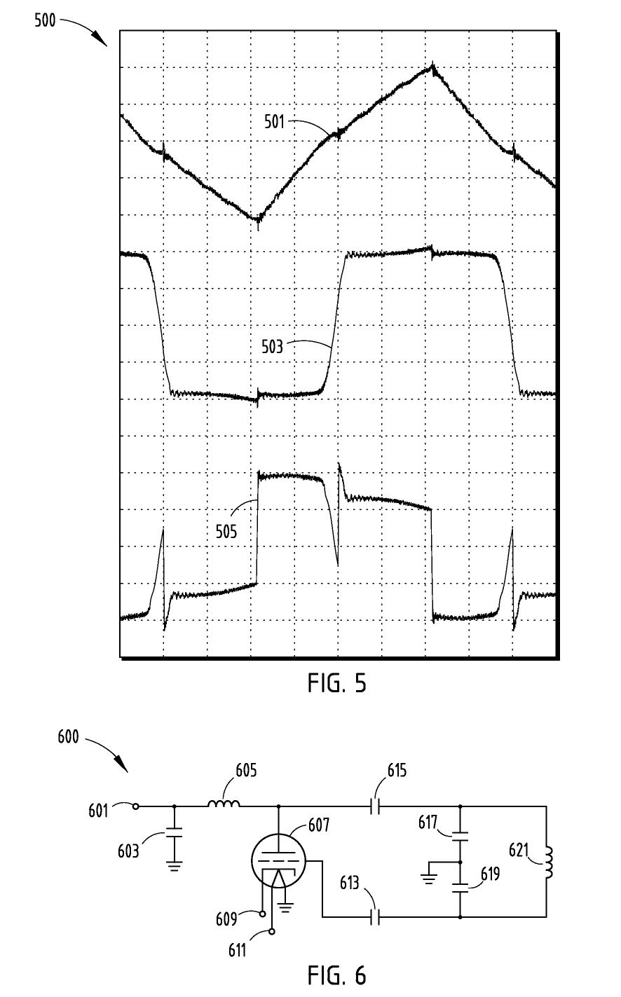

FIG. 5 illustrates various waveforms that occur at the inverter 307 output shown in FIG. 3. These waveforms include the output current 501, the primary transformer voltage 503 (i.e., the voltage across the transformer 311 primary) and the inductor voltage 505 (i.e., the voltage across the inductor 309). These waveforms illustrate a transformer primary voltage and current that is free of oscillation and ringing.

The forward-flyback topology, as described herein, applies an input voltage to the primary winding of the transformer 311 that is in series with the inductor 309. The inverter 307 is switched as a phase controlled full bridge for providing duty cycle control. This topology is similar to a forward converter since during the “on” time, the transformer provides an output voltage that is a “scaled” version of its primary voltage (the inverter output voltage less the voltage on the inductor 309). The topology also provides characteristics of a flyback converter since during the “on” time, the inductor 309 stores a portion of the applied energy as magnetic flux. During the “off” time of the inverter, this stored energy is delivered to the output 317 through the transformer 311.

As described herein, the output voltage at the transformer secondary is controlled by varying the duty cycle of the inverter. Unlike supplies used in the prior art, such as U.S. Pat. No. 5,349,514 to Ushiki et al. entitled “Reduced-Resonant-Current Zero-Voltage-Switched Forward Converter Using Saturable Inductor,” which is incorporated herein by reference, the present invention does not require the use of an inductive component in an output filter network. Unlike the supply shown by Ushiki et al., the inductance provided by the inductor 309 is not used to “resonate” the switching waveforms from the switching network. Instead, it is used to store energy.

The invention provides a substantially one hundred percent (100%) utilization of the transformer 311 over a wide operating voltage range, improving efficiency and reducing primary and secondary peak currents and ripple currents. Moreover, this operation simplifies filtering requirements and the value of any output filter inductor used in an output filter network can be greatly reduced or eliminated. Thus, in one embodiment, the inductor 309 acts as a filter element of a forward converter during its “on” time while acting as an energy storage element of a flyback converter during the “off” time. Neither a substantially high value output filter capacitance nor a filter inductor is required to provide a substantially low ripple output voltage. Finally, another advantage is that the load presented by the inverter 307 to an AC mains voltage input 301 will have a near unity power factor with low harmonic distortion.

FIG. 6 is a schematic diagram of an RF oscillator that may be used in connection with the switching power supply shown in FIG. 3. The RF oscillator 600 includes a rectified AC input 601 supplied by the power supply shown in FIG. 3. An input filter consisting of a capacitor 603 and an inductor 605 allow the low frequency modulated DC voltage (47-63 Hz) to power the RF oscillator 600 while preventing any RF energy from returning to the power supply. The vacuum tube 607 includes a plate or anode that is connected to the power supply through the inductor 605. The plate is connected by the capacitor 615 to a resonant network consisting of an induction coil 621 and the capacitors 617 and 619. Although the vacuum tube 607 is depicted as a triode, other types of high power vacuum tube types can be used for supplying a substantially high amount of RF energy at a predetermined frequency. An input 609 depicts a cathode voltage input while an input 611 is a filament supply voltage input. A grid capacitor 613 works in combination with the resonant network for providing feedback to the grid of the vacuum tube 607 which induces an oscillation at a predetermined frequency. Thereafter, a substantially high RF voltage and current is supplied to the induction coil 621 in an analytical induction furnace. The induction furnace is used for combusting various materials to create vaporized gases for subsequent analysis.

Thus, an embodiment of the invention is a switching power supply for use with an analytical induction furnace for providing power to a transformer coupled load containing large parasitic circuit elements between the primary and secondary load. The power supply includes an inverter operating at a high switching frequency and a transformer. An inductor is connected in series with a primary winding of the transformer for providing energy storage and filtering of the transformer secondary load circuit at the inverter switching frequency.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential feature or element of any or all the claims. The invention is defined solely by the appended claims including any amendments made during the pendency of this application and all equivalents of those claims as issued.

We claim:

1. A switching power supply for providing power to a transformer coupled load comprising:
an inverter for switching an input voltage;
at least one transformer for changing the amplitude of a first output voltage supplied from the inverter; and
an inductor connected in series with at least one primary winding of the at least one transformer for filtering a second output voltage applied to at least one load coupled with a secondary winding.

2. A switching power supply as in claim 1, wherein the inductor filters the first output voltage provided by the inverter.

3. A switching power supply as in claim 1, wherein the inductor stores energy from the first output voltage provided from the inverter.

4. A switching power supply as in claim 1, wherein the at least one transformer provides galvanic isolation from the at least one primary winding of the at least one transformer to the at least one load.

5. A switching power supply as in claim 1, wherein the inverter is comprised of a network of switching devices.

6. A switching power supply as in claim 1, wherein the inverter is comprised of at least one half bridge network for switching an input voltage.

7. A switching power supply as in claim 6, wherein the at least one half bridge network is comprised of a plurality of series connected switching devices.

8. A switching power supply as in claim 1, wherein the inverter is controlled by a switching controller for controlling the states of the inverter.

9. A switching power supply as in claim 8, wherein the switching controller operates the inverter at a near unity power factor.

10. A switching power supply as in claim 8, wherein the switching controller operates each half bridge network at a substantially 50% duty cycle.

11. A switching power supply as in claim 1, wherein an input to the inverter is connected with an input filter network for preventing voltage or current transients.

12. A switching power supply as in claim 1, further comprising an output filter using no inductive element.

13. A switching power supply as in claim 1, further comprising at least one switching device for rectifying an AC power source of the switching power supply.

14. A switching power supply as in claim 1, further comprising an input filter for reducing harmonic distortion of a power source of the switching power supply.

15. A switching power supply as in claim 1, wherein the at least one transformer supplies a voltage to a radio frequency (RF) oscillator in an induction furnace.

16. A switching power supply for use with an RF induction furnace comprising:
an inverter formed using at least one half bridge network providing a switched output voltage;
at least one transformer having at least one primary winding connected to the inverter and a secondary winding connected to at least one load; and
an inductor connected in series with the at least one primary winding for filtering a voltage supplied to the at least one load coupled with the secondary winding.

17. A switching power supply as in claim 16, wherein the inductor filters the voltage provided by the inverter.

18. A switching power supply as in claim 16, wherein the inductor stores energy from at least one switched output voltage provided from the inverter.

19. A switching power supply as in claim 16, wherein the at least one transformer provides galvanic isolation from the at least one primary winding to the at least one load.

20. A switching power supply as in claim 16, wherein the inverter is comprised of a network of switching devices.

21. A switching power supply as in claim 16, wherein the inverter is comprised of at least one half bridge network for switching an input voltage.

22. A switching power supply as in claim 21, wherein the at least one half bridge network is comprised of a plurality of series connected switching devices.

23. A switching power supply as in claim 16, wherein the inverter is controlled by a switching controller for controlling the states of the inverter.

24. A switching power supply as in claim 23, wherein the switching controller operates the inverter at a near unity power factor.

25. A switching power supply as in claim 23, wherein the switching controller operates each half bridge network at a substantially 50% duty cycle.

26. A switching power supply as in claim 16, wherein an input to the inverter is connected with an input filter network for preventing voltage or current transients.

27. A switching power supply as in claim 16, further comprising an output filter using no inductive element.

28. A switching power supply as in claim 16, further comprising at least one switching device for rectifying an AC power source of the switching power supply.

29. A switching power supply as in claim 16, further comprising an input filter for reducing harmonic distortion of a power source of the switching power supply.

30. A switching power supply as in claim 16, wherein the at least one transformed supplies a voltage to a radio frequency (RF) oscillator in an induction furnace.

31. A switching power supply for providing a voltage to a radio frequency (RF) oscillator used in an induction furnace comprising:
an input rectifier;
an inverter using at least one half bridge network for switching an input voltage provided from the input rectifier where each half bridge network uses a plurality of switching devices controlled by the switching controller;
a switching controller for controlling the switching frequency of the inverter;
at least one transformer having at least one primary winding connected to the inverter and a secondary winding connected to an RF oscillator; and
an inductor connected in series with the at least one primary winding for filtering a voltage applied to the RF oscillator.

32. A switching power supply as in claim 31, wherein an input to the inverter is connected with an input filter network for preventing voltage or current transients.

33. A switching power supply as in claim 31, wherein the switching controller operates each half bridge network at a substantially 50% duty cycle.

34. A switching power supply as in claim 31, wherein the switching devices are insulated gate bipolar transistors (IGBT) and diodes.

35. A switching power supply as in claim 31, wherein the inverter is switched at a frequency of approximately 25 kHz.

36. A method for efficiently transferring power to a transformer secondary winding in a switching power supply comprising the steps of:
producing a switched voltage from an inverter;
providing the switched voltage to a transformer; and
utilizing an inductor connected in series with a primary winding of the transformer for filtering a voltage applied to a load coupled with a secondary winding.

37. A method for efficiently providing power to a transformer secondary winding as in claim 36, further comprising the step of:
connecting the switching inverter to a filter network for isolating inverter currents from an AC power source.

38. A method for efficiently providing power to a transformer secondary winding as in claim 36, further comprising the step of:
using at least one half bridge network in the inverter for switching an input voltage.

39. A method for efficiently providing power to a transformer secondary winding as in claim 38, further comprising the step of:
forming each half bridge network using insulated gate bipolar transistors (IGBT) and diodes.

40. A method for efficiently providing power to a transformer secondary winding as in claim 38, further comprising the steps of:
controlling the switching frequency of the inverter using a switching controller.

41. A method for efficiently providing power to a transformer secondary winding as in claim 38, further comprising the step of:
controlling the inverter to provide a near unity power factor.

42. A method for efficiently providing power to a transformer secondary winding as in claim 38, further comprising the step of:
operating each half bridge network at a substantially 50% duty cycle.

43. A method for efficiently providing power to a transformer secondary winding as in claim 38, further comprising the step of:
providing at least one switching device for providing a rectified voltage to the inverter from an AC power source.

44. A method for efficiently providing power to a transformer secondary winding as in claim 36, further comprising the step of:
connecting the transformer to a radio frequency (RF) oscillator in an induction furnace.
